(19) United States
(12) Patent Application Publication
(10) Pub. No.: US 2017/0126341 A1
(43) Pub. Date: May 4, 2017

(54) FAM TRANSMITTING APPARATUS AND METHOD FOR COMBINING FM SIGNAL AND DIGITAL MODULATED AM SIGNAL

(71) Applicant: Electronics and Telecommunications Research Institute, Daejeon (KR)

(72) Inventors: Young Su KIM, Daejeon (KR); Kyu Tae YANG, Daejeon (KR); Hyoung Soo LIM, Daejeon (KR); Bong Ho LEE, Daejeon (KR); Nam Ho HUR, Sejong (KR)

(21) Appl. No.: 15/337,642

(22) Filed: Oct. 28, 2016

(30) Foreign Application Priority Data
Oct. 29, 2015 (KR) 10-2015-0151303
Aug. 5, 2016 (KR) 10-2016-0100314

(51) Int. Cl. H04H 20/49; H04H 20/88; H04H 40/45; H04H 20/48

(52) U.S. Cl. CPC H04H 20/49; H04H 20/48; H04H 20/88; H04H 40/45

(57) ABSTRACT

Disclosed is a frequency amplitude modulation (FAM) transmission apparatus and method by combining a frequency modulation (FM) signal and a digital modulated amplitude modulation (AM) signal. A FAM transmission method includes receiving an FM signal created by modulating an audio signal that includes audio information for mono or stereo broadcasting based on an FM scheme; receiving a digital pulse created by modulating digital data used to provide an additional service for the mono or stereo broadcasting based on an amplitude modulation (AM) affiliated digital modulation scheme; creating an AM signal by by adjusting the digital pulse to have a value greater than 0; and creating a FAM signal by combining the FM signal and the AM signal.

### CROSS-REFERENCE TO RELATED APPLICATION(S)

This application claims the priority benefit of Korean Patent Application No. 10-2015-0151303 filed on Oct. 29, 2015, and Korean Patent Application No. 10-2016-0100314 filed on Aug. 5, 2016, in the Korean Intellectual Property Office, the disclosures of which are incorporated herein by reference for all purposes.

### BACKGROUND

1. Field

One or more example embodiments relate to a frequency amplitude modulation (FAM) transmission apparatus and method by combining a frequency modulation (FM) signal and a digital modulated amplitude modulation (AM) signal, and more particularly, to an apparatus and method for transmitting a FAM signal created by combining an FM signal and a digital modulated AM signal.

2. Description of Related Art

Technology for carrying and thereby transmitting digital data in a frequency modulation (FM) signal has been developed to provide an additional service, for example, traffic information, news, program information, text information, etc., to FM broadcasting. Such a data transmission scheme includes, for example, a radio data system (RDS), a data radio channel (DARC), a radio broadcasting data system (RBDS), and the like.

In the recent times, an amount of digital data used to provide a variety of additional services is quickly increasing. Thus, there are some constraints on transmitting a surprisingly increasing large amount of digital data using an existing transmission scheme.

Accordingly, there is a need for technology that may transmit digital data in addition to a data transmission capacity provided from an existing transmission scheme in order to transmit a surprisingly increasing large amount of digital data.

### SUMMARY

One or more example embodiments provide an apparatus and method that may increase a transmission capacity of digital data used to provide an additional service by additionally transmitting the digital data through combination of a frequency modulation (FM) signal and a digital modulated amplitude modulation (AM) signal, in addition to a digital data transmission capacity provided from a digital data transmission scheme, for example, a radio data system (RDS), a data radio channel (DARC), a radio broadcasting data system (RBDS), etc., in FM broadcasting.

According to an aspect of one or more example embodiments, there is provided a frequency amplitude modulation (FAM) transmission method, including receiving an FM signal created by modulating an audio signal that includes audio information for mono or stereo broadcasting based on an FM scheme; receiving a digital pulse created by modulating digital data used to provide an additional service for the mono or stereo broadcasting based on an amplitude modulation (AM) affiliated digital modulation scheme; creating an AM signal by adjusting the digital pulse to have a value greater than 0; and creating a FAM signal by combining the FM signal and the AM signal.

The audio signal may include the digital modulation signal based on an RDS, a DARC, and an RBDS used to provide the additional service for the mono or stereo broadcasting.

The creating of the AM signal may include adding a direct current (DC) value to the digital pulse so that the created AM signal has a value greater than 0; and the creating of the FAM signal may include multiplying the FM signal by the AM signal to which the DC value is added.

A bandwidth of the FAM signal may be adjusted based on a transmission rate of the digital data, a coefficient of a pulse shaping filter used to modulate the digital data to the digital pulse, and a maximum frequency deviation of the FM signal.

The created AM signal may have a modulation index between 0 and 1.

According to an aspect of one or more example embodiments, there is provided a FAM reception method, including receiving a FAM signal created by combining an FM signal and a digitally modulated AM signal; extracting the FM signal from the received FAM signal using a limiter configured to constantly limit an amplitude of a signal; and outputting an audio signal that includes audio information for mono or stereo broadcasting by demodulating the extracted FM signal based on an FM demodulation scheme.

The FAM signal may be created by multiplying the FM signal by the AM signal to which a direct current (DC) value is added so that the AM signal has a value greater than 0.

A bandwidth of the FAM signal may be adjusted based on a transmission rate of the digital data, a coefficient of a pulse shaping filter used to modulate the digital data to a digital pulse, and a maximum frequency deviation of the FM signal.

The AM signal may have a modulation index between 0 and 1.

According to an aspect of one or more example embodiments, there is provided a FAM reception method, including receiving a FAM signal created by combining an FM signal and a digitally modulated AM signal; extracting the digitally modulated AM signal from the received FAM signal by applying a noncoherent detection scheme to the received FAM signal; and outputting digital data by demodulating the extracted digitally modulated AM signal based on a digital demodulation scheme.

The FAM signal may be created by multiplying the FM signal by the AM signal to which a direct current (DC) value is added so that the AM signal has a value greater than 0.

A bandwidth of the FAM signal may be adjusted based on a transmission rate of digital data, a coefficient of a pulse shaping filer used to modulate the digital data to a digital pulse, and a maximum frequency deviation of the FM signal.

The AM signal may have a modulation index between 0 and 1.

According to some example embodiments, it is possible to increase a transmission capacity of digital data used to provide an additional service by additionally transmitting the digital data through combination of a frequency modulation (FM) signal and a digital modulated amplitude modulation (AM) signal, in addition to a digital data transmission capacity provided from a digital data transmission scheme, for example, an RDS, a DARC, an RBDS, etc., in FM broadcasting that transmits digital data.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a block diagram illustrating a frequency amplitude modulation (FAM) transmission system according to an example embodiment;

FIG. 2 illustrates examples of a signal waveform according to an example embodiment; and

FIG. 3 is a diagram illustrating a FAM reception system according to an example embodiment.

### DETAILED DESCRIPTION

Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings. Also, in the description of embodiments, detailed description of well-known related structures or functions will be omitted when it is deemed that such description will not cause ambiguous interpretation of the present disclosure.

The following detailed structural or functional description of example embodiments is provided as an example only and various alterations and modifications may be made to the example embodiments. Accordingly, the example embodiments are not construed as being limited to the disclosure and should be understood to include all changes, equivalents, and replacements within the technical scope of the disclosure.

Terms, such as first, second, and the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component. On the contrary, it should be noted that if it is described that one component is “directly connected”, “directly coupled”, or “directly joined” to another component, a third component may be absent. Expressions describing a relationship between components, for example, “between”, directly between”, or “directly neighboring”, etc., should be interpreted to be alike.

The singular forms “a”, “an”, and the are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

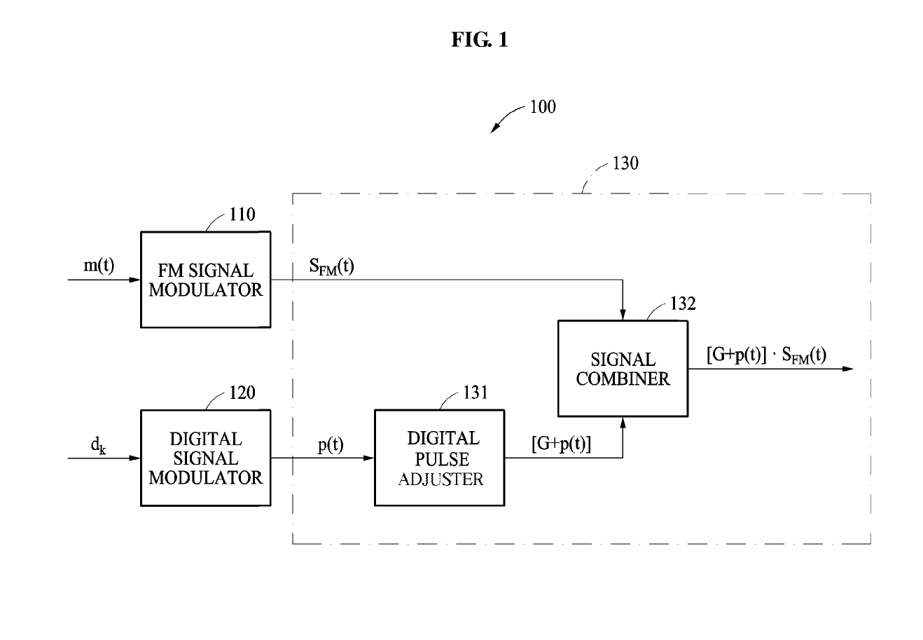

FIG. 1 is a block diagram illustrating a frequency amplitude modulation (FAM) transmission system according to an example embodiment.

Radio broadcasting or television (TV) broadcasting may transmit an audio signal by carrying the audio signal in a radio wave by spatially broadcasting the audio signal, instead of transmitting the audio signal in an electric wave form. Here, a process of carrying an audio signal in a radio wave is referred to as a modulation process and the radio wave used for the modulation process is referred to a carrier.

A frequency modulation (FM) scheme may modulate a frequency of carrier that carries an audio signal. Accordingly, dissimilar to an amplitude modulation (AM) scheme, the amplitude of a FM signal may be constant instead of varying over time. The FM scheme has a characteristic in that a change in amplitude of a received FM signal barely affects a demodulation performance since information of an audio signal is contained in a frequency of carrier. Accordingly, due to the above characteristic, without causing a significant degradation in the performance, the FM signal may be demodulated from a FAM signal created by multiplying the FM signal modulated based on the FM scheme by an AM signal modulated based on the AM scheme.

Likewise, an amplitude of a modulated FM signal may be constant and may barely affect an AM signal transmitted by being multiplied by the FM signal. Due to the above characteristic, without causing a significant degradation in the performance, the AM signal may be demodulated from a FAM signal created by multiplying the FM signal modulated based on the FM scheme by the AM signal modulated based on the AM scheme.

Referring to FIG. 1, a FAM transmission system 100 according to an example embodiment may include an FM signal modulator 110, a digital signal modulator 120, and a FAM transmission apparatus 130. The FM signal modulator 110 may create a FM signal S_{FM}(t) by modulating an audio signal m(t) that includes audio information for mono or stereo broadcasting based on an FM scheme.

Here, the FM signal S_{FM}(t) modulated at the FM signal modulator 110 may be represented as Equation 1.

S_{FM}(t)=A_{FM} cos(2πf_{c}t+2πk_{f}∫₀^{t}m(t)dt) [Equation 1]

In Equation 1, the audio signal m(t) refers to a baseband signal that includes audio information for mono or stereo broadcasting as a modulation signal, and may also include a digital modulation signal used to provide an additional service for FM broadcasting, such as a radio data system (RDS), a data radio channel (DARC), a radio broadcasting data system (RBDS), and the like. Here, A_{FM} denotes the amplitude of the FM signal S_{FM}(t), f_{c} denotes a carrier frequency of the FM signal S_{FM}(t), and k_{f} denotes a constant that determines a maximum frequency deviation of the FM signal S_{FM}(t).

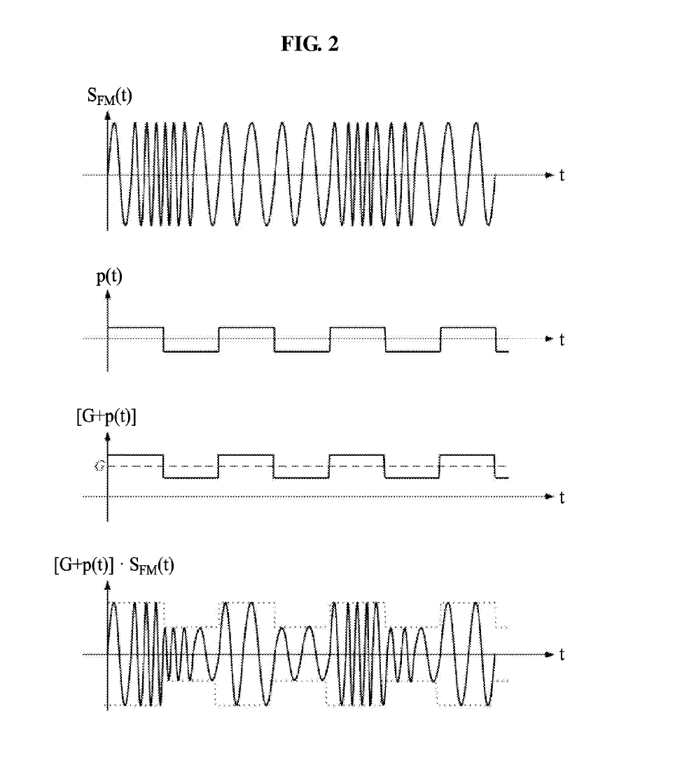

The digital signal modulator 120 may create a digital pulse by modulating digital data dₖ where k=0, 1, 2, . . . , used to provide an additional service for mono or stereo broadcasting based on an AM affiliated digital modulation scheme. Here, the created digital pulse may have a form of a digital pulse p(t) as FIG. 2.

For example, the digital signal modulator 120 may modulate digital data by applying an AM affiliated digital modulation scheme, such as an amplitude shift keying (ASK) modulation scheme, a pulse amplitude modulation (PAM) modulation scheme, and the like.

The FAM transmission apparatus 130 may include a digital pulse adjuster 131 and a signal combiner 132. The digital pulse adjuster 131 may receive the digital pulse p(t) created at the digital signal modulator 120. The digital pulse adjuster 131 may create an AM signal S_{AM}(t) by adjusting the received digital pulse p(t) to have a value greater than 0 in order to carry and thereby transmit digital data in the FM signal S_{FM}(t).

Here, the digital pulse tuner 131 may add a direct current (DC) G to the digital pulse p(t) and may create the AM signal S_{AM}(t) so that [G+p(t)] may have a value greater than 0 at all times. This is because a phase of the FM signal S_{FM}(t) is inverted if [G+p(t)] corresponding to an envelope of the AM signal S_{AM}(t) has a negative value. To prevent this, the digital pulse adjuster 131 needs to determine a DC G value so that [G+p(t)] may have a positive value at all times. The AM signal S_{AM}(t) may be represented as Equation 2.

S_{AM}(t)=[G+p(t)]·cos(2πf_{c}t) [Equation 2]

The signal combiner 132 may create a FAM signal S_{FAM}(t) by multiplying the FM signal S_{FM}(t) received from the FM signal modulator 110 by the AM signal S_{AM}(t) received from the digital pulse adjuster 131. Here, the signal combiner 132 may create the FAM signal S_{FAM}(t) by multiplying the FM signal S_{FM}(t) modulated based on the characteristic of the FM scheme by the AM signal S_{AM}(t) modulated from the digital data based on the characteristic of the AM scheme.

That is, the signal combiner 132 may create the FAM signal S_{FAM}(t) by multiplying the FM signal S_{FM}(t) by [G+p(t)] of the AM signal S_{AM}(t) corresponding to an envelope of the FAM signal S_{FAM}(t). The FAM signal S_{FAM}(t) may be represented as Equation 3.

S_{FAM}(t)=[G+p(t)]·S_{FM}(t) [Equation 3]

In Equation 3, the FAM signal S_{FAM}(t) refers to a signal to which both of the DSB-LC AM scheme and the FM scheme are applied. The digital pulse p(t) modulated from the digital data and the audio signal m(t) may be transmitted together. Here, if the FM signal S_{FM}(t) is regarded as carrier, the FAM signal S_{FAM}(t) may be regarded as a form of a signal of which amplitude is modulated based on the DSB-LC scheme.

If [G+p(t)] of the AM signal S_{AM}(t) corresponding to the envelope of the FAM signal S_{FAM}(t) is a positive value, the digital pulse p(t) may be simply demodulated by applying a noncoherent detection scheme to the FAM signal S_{FAM}(t).

The signal combiner 132 may spatially broadcast the created FAM signal S_{FAM}(t).

FIG. 2 illustrates examples of a signal waveform according to an example embodiment.

FIG. 2 illustrates waveform examples of an FM signal S_{FM}(t), a digital pulse p(t), [G+p(t)] of an AM signal S_{AM}(t) corresponding to an envelope of a FAM signal S_{FAM}(t), and [G+p(t)]·S_{FM}(t) of the FAM signal S_{FAM}(t).

Here, the digital pulse p(t) is an example of a square wave. In an actual system, the digital pulse p(t) is created using a pulse shaping filter, such as a square-root raised cosine filter, and thus may be provided in a pulse shape that further gradually varies compared to the digital pulse p(t) of FIG. 2.

A spectrum of the FAM signal S_{FAM}(t) is determined based on convolution between a spectrum of the digital pulse p(t) and a spectrum of the FM signal S_{FM}(t). Accordingly, a bandwidth of the FAM signal S_{FAM}(t) is determined based on a bandwidth of the digital pulse p(t) and a bandwidth of the FM signal S_{FM}(t). The FAM transmission apparatus 130 may adjust the bandwidth of the FAM signal S_{FAM}(t) based on a transmission rate of digital data dₖ, coefficients of the pulse shaping filter of the digital signal modulator 120, and a constant k_{f} for determining a maximum frequency deviation of the FM signal S_{FM}(t).

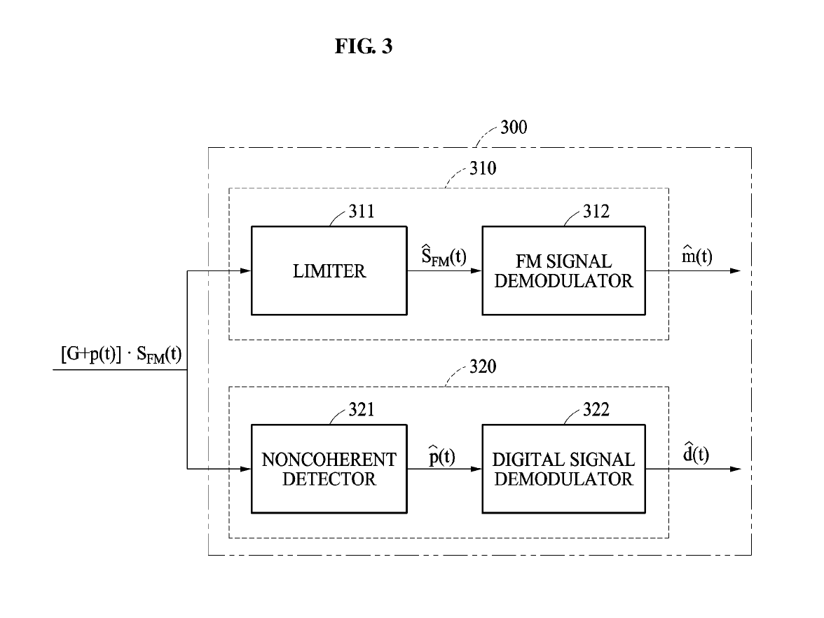

FIG. 3 is a diagram illustrating a FAM reception system according to an example embodiment.

Referring to FIG. 3, a FAM reception system 300 may include an FM signal demodulation apparatus 310 and a digital signal demodulation apparatus 320. The FM signal demodulation apparatus 310 may include a limiter 311 configured to constantly limit an amplitude of a signal and an FM signal demodulator 312 configured to demodulate an FM signal based on an FM scheme. The digital signal demodulation apparatus 320 may include a noncoherent detector 321 configured to extract an AM signal by applying a noncoherent detection scheme to a FAM signal, and a digital signal demodulator 322 configured to demodulate the AM signal.

In AM, a modulation index may be defined as expressed by Equation 4 and the example embodiments follow the definition.

$$μ = \frac{\vert min p ( t ) \vert}{G} \qquad [ Equation 4 ]$$

The noncoherent detector 321 may extract the digital pulse p(t) that is the AM signal from the FAM signal S_{FAM}(t) received at the FAM reception system 300 using a noncoherent detection scheme, for example, an envelope detector. Here, the modulation index μ of the AM signal is to satisfy the condition of 0<μ<1.

The modulation index μ may be used to determine a relative amplitude ratio between the FM signal S_{FM}(t) and the digital pulse p(t). That is, as the modulation index μ approaches 1, the relative amplitude of the digital pulse p(t) to the FM signal S_{FM}(t) increases. Thus, at the FAM reception system 300, the reception performance of the digital pulse p(t) may be enhanced and the reception performance of the FM signal S_{FM}(t) may be degraded. As the modulation index μ approaches 0, the relative amplitude of the digital pulse p(t) to the FM signal S_{FM}(t) decreases. Thus, at the FAM reception system 300, the reception performance of the digital pulse p(t) may be degraded and the reception performance of the FM signal S_{FM}(t) may be enhanced.

Accordingly, the relative reception performance of the FM signal S_{FM}(t) and the digital pulse p(t), that is, the relative reception performance of the audio signal m(t) and digital data dₖ may be adjusted by adjusting the modulation index μ. The modulation index μ may be changed by adjusting a G value of FIG. 1, and need to have a small value in order to minimize the effect of [G+p(t)] of Equation 3 against the demodulation performance of the FM signal S_{FM}(t).

The FM signal demodulation apparatus 310 may function to extract the audio signal m(t) from the FAM signal S_{FAM}(t), and the digital signal demodulation apparatus 320 may function to extract the digital data dₖ from the FAM signal S_{FAM}(t).

The limiter 311 of the FM signal demodulation apparatus 310 may function to make a signal amplitude be constant by removing [G+p(t)] that is an envelope component of the received FAM signal [G+p(t)]·S_{FM}(t). Since an output signal Ŝ_{FM}(t) of the limiter 311 is an FM signal, an estimate \hat{m}(t) of the audio signal m(t) may be output by demodulating the output signal Ŝ_{FM}(t) based on an FM demodulation scheme using the FM signal demodulator 312.

On the contrary, the received FAM signal [G+p(t)]·S_{FM}(t) is modulated from the digital pulse p(t) based on a DSB-LC scheme. Accordingly, the digital signal demodulation apparatus 320 may detect the digital pulse p(t) from the FAM signal [G+p(t)]·S_{FM}(t) based on a noncoherent detection scheme using the noncoherent detector 321, such as the envelope detector. That is, the noncoherent detector 321 functions to output an estimate \hat{p}(t) of the digital pulse p(t) that is an AM component from the received FAM signal [G+p(t)]·S_{FM}(t). Here, since the output estimate is the AM signal, an estimate \hat{d}ₖ of the digital data dₖ may be output by demodulating the output estimate \hat{p}(t) based on an AM affiliated digital modulation scheme, such as PAM or ASK, using the digital signal demodulator 322.

The units and/or modules described herein may be implemented using hardware components, software components, and/or combination thereof. For example, the hardware components may include microphones, amplifiers, band-pass filters, audio to digital convertors, and processing devices. A processing device may be implemented using one or more hardware device configured to carry out and/or execute program code by performing arithmetical, logical, and input/output operations. The processing device(s) may include a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct and/or configure the processing device to operate as desired, thereby transforming the processing device into a special purpose processor. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A frequency amplitude modulation (FAM) transmission method, comprising:
receiving a frequency modulation (FM) signal created by modulating an audio signal that includes audio information for mono or stereo broadcasting based on an FM scheme
receiving a digital pulse created by modulating digital data used to provide an additional service for the mono or stereo broadcasting based on an amplitude modulation (AM) affiliated digital modulation scheme;
creating an AM signal by adjusting the digital pulse to have a value greater than 0; and
creating a FAM signal by combining the FM signal and the AM signal.

2. The method of claim 1, wherein the audio signal includes the digital modulation signal based on a radio data system (RDS), a data radio channel (DARC), and a radio broadcasting data system (RBDS) used to provide the additional service for the mono or stereo broadcasting.

3. The method of claim 1, wherein the creating of the AM signal comprises:
adding a direct current (DC) value to the digital pulse so that the created AM signal has a value greater than 0; and
wherein the creating of the FAM signal comprises:
multiplying the FM signal by the AM signal to which the DC value is added.

4. The method of claim 1, wherein a bandwidth of the FAM signal is adjusted based on a transmission rate of the digital data, coefficients of a pulse shaping filter used to modulate the digital data to the digital pulse, and a maximum frequency deviation of the FM signal.

5. The method of claim 1, wherein the created AM signal has a modulation index between 0 and 1.

6. A frequency amplitude modulation (FAM) reception method, comprising:
receiving a FAM signal created by combining a frequency modulation (FM) signal and a digitally modulated amplitude modulation (AM) signal;
extracting the FM signal from the received FAM signal using a limiter configured to constantly limit an amplitude of a signal; and
outputting an audio signal that includes audio information for mono or stereo broadcasting by demodulating the extracted FM signal based on an FM demodulation scheme.

7. The method of claim 6, wherein the FAM signal is created by multiplying the FM signal by the AM signal to which a direct current (DC) value is added so that the AM signal has a value greater than 0.

8. The method of claim 6, wherein a bandwidth of the FAM signal is adjusted based on a transmission rate of the digital data, coefficients of a pulse shaping filter used to modulate the digital data to a digital pulse, and a maximum frequency deviation of the FM signal.

9. The method of claim 6, wherein the AM signal has a modulation index between 0 and 1.

10. A frequency amplitude modulation (FAM) reception method, comprising:
receiving a FAM signal created by combining a frequency modulation (FM) signal and a digitally modulated amplitude modulation (AM) signal;
extracting the digitally modulated AM signal from the received FAM signal by applying a noncoherent detection scheme to the received FAM signal; and
outputting digital data by demodulating the extracted digitally modulated AM signal based on a digital demodulation scheme.

11. The method of claim 10, wherein the FAM signal is created by multiplying the FM signal by the AM signal to which a direct current (DC) value is added so that the AM signal has a value greater than 0.

12. The method of claim 10, wherein a bandwidth of the FAM signal is adjusted based on a transmission rate of digital data, coefficients of a pulse shaping filer used to modulate the digital data to a digital pulse, and a maximum frequency deviation of the FM signal.

13. The method of claim 10, wherein the AM signal has a modulation index between 0 and 1.
